(19) United States
(12) Patent Application Publication
(10) Pub. No.: US 2026/0213866 A1
(43) Pub. Date: Jul. 23, 2026

(54) METHOD FOR DATA COMMUNICATION BASED ON TIME DIVISION MULTIPLE ACCESS AND APPARATUS THEREFOR

(71) Applicant: AGENCY FOR DEFENSE DEVELOPMENT, Daejeon (KR)

(72) Inventors: Sung Young CHO, Daejeon (KR); Young Il CHO, Daejeon (KR); Young Hoon GOO, Daejeon (KR); Jin Ki KIM, Daejeon (KR); Sin Uk CHOI, Daejeon (KR); Won Cheol CHO, Daejeon (KR); Dong Hyun LEE, Daejeon (KR); Won Ki LIM, Daejeon (KR)

(21) Appl. No.: 19/449,916

(22) Filed: Jan. 15, 2026

(30) Foreign Application Priority Data
Jan. 23, 2025 (KR) 10-2025-0010723

(51) Int. Cl. H04J 3/16; H04B 7/26

(52) U.S. Cl. CPC H04J 3/1694; H04B 7/2606; H04B 7/2643

(57) ABSTRACT

Systems, devices, methods, and instructions for data communication based on time division multiple access (TDMA), performed by a central office of a network, including identifying a plurality of nodes included in the network, configuring a unit time frame for data communication of the network, such that a plurality of dedicated time slots allocated for data transmission of each of the plurality of nodes and a shared time slot allocated and shared for the data transmission of the plurality of nodes are included, identifying, among the plurality of nodes, a final-stage node predicted to enter a communication-disabled state within a predetermined time period based on status information of each node included the plurality of nodes received from the dedicated time slot, and activating the shared time slot for the final-stage node.

### PRIORITY INFORMATION

This application claims the benefit of Korean Patent Application No. 10-2025-0010723, filed on January 23, 2025, in the Korean Intellectual Property Office, the disclosure of which is incorporated herein by reference.

### FIELD OF THE INVENTION

The present disclosure relates to telecommunications, and more particularly to, systems, devices, methods and instructions for data communication based on time division multiple access (TDMA).

### DISCUSSION OF THE RELATED ART

In a time division multiple access (TDMA)-based network, a node joined the network may transmit data through a time slot allocated to the node. Due to such a characteristic of the TDMA-based network, the length of the time slot allocated to each node may be limited by the number of nodes within the network. In case a particular node is disabled for communication before it has transmitted all necessary data, the receiving node may not be able to receive the complete data.

Specifically, in a network between nodes corresponding to terminals utilized for specific tasks (e.g., guided missiles and survey drones) and a central office communicating with these nodes, one or more nodes may enter a communication-disabled state, for instance due to physical destruction, depending on the task assigned to the terminal. In this case, large volumes of obtained data may need to be transmitted to the central office before the node transitions to the communication-disabled state. However, it is not possible to efficiently transmit such a large volume data within a limited time slot in the TDMA-based network, which may result in potential data loss.

Alternatively, allocating more time slots to each node of the TDMA-based network to address this problem will result in inefficient utilization of the allocated time slots when massive data transmission is not required, thereby degrading the availability of the network time frame and overall network resources.

For this reason, technology for efficiently allocating time slots in TDMA-based network communication based on the characteristics of the tasks performed by the corresponding nodes joined the network is required.

In this regard, related documents such as KR101788196B1 may be referred to.

### SUMMARY

Accordingly, the present disclosure is directed to systems, devices, methods and instructions for data communications based on time division multiple access (TDMA) that substantially obviates one or more problems due to limitations and disadvantages of the related art.

An aspect provides a method for data communication based on time division multiple access (TDMA), performed by a central office of a network, including identifying a plurality of nodes included in the network, configuring a unit time frame for data communication of the network, such that a plurality of dedicated time slots allocated for data transmission of each of the plurality of nodes and a shared time slot allocated and shared for the data transmission of the plurality of nodes are included, identifying, among the plurality of nodes, a final-stage node predicted to enter a communication-disabled state within a predetermined time period based on status information of each node included the plurality of nodes received from the dedicated time slot, and activating the shared time slot for the final-stage node.

The goals to be achieved by example embodiments of the present disclosure are not limited to the objects described above, and other objects may be inferred from the following example embodiments.

According to an aspect, there is provided a method for data communication based on time division multiple access (TDMA), performed by a central office of a network, the method including identifying a plurality of nodes included in the network, configuring a unit time frame for data communication of the network, such that a plurality of dedicated time slots allocated for data transmission of each of the plurality of nodes and a shared time slot allocated and shared for the data transmission of the plurality of nodes are included, identifying, among the plurality of nodes, a final-stage node predicted to enter a communication-disabled state within a predetermined time period based on status information of each node included the plurality of nodes received from the dedicated time slot, and activating the shared time slot for the final-stage node.

The plurality of nodes are predicted to sequentially enter the communication-disabled state according to a predetermined task.

The configuring of the unit time frame includes configuring the unit time frame, such that the shared time slot includes more time slots than the plurality of dedicated time slots.

The identifying of the final-stage node includes identifying whether each node is predicted to enter the communication-disabled state within the predetermined time period based on at least one of location information, target detection information, and speed information, of each node, included in the status information of each node, and identifying the final-stage node based on whether each node is predicted to enter the communication-disabled state within the predetermined time period.

The activating of the shared time slot for the final-stage node includes obtaining a user input confirming whether to activate the shared time slot for the final-stage node and activating the shared time slot for the final-stage node in response to the input.

The method further includes identifying, when the final-stage node is confirmed to be in the communication-disabled state, a new final-stage node predicted to enter the communication-disabled state within the predetermined time period based on the status information of each node of nodes remaining after excluding the final-stage node from the plurality of nodes, and activating the shared time slot for the new final-stage node.

The configuring of the unit time frame includes identifying, among the plurality of nodes, a relay node to perform relay transmission of the plurality of nodes, and configuring the unit time frame to further include a relay time slot allocated for the relay transmission.

The identifying of the relay node includes identifying, among the plurality of nodes, a node nearest to the central office among nodes determined to be in a line of sight (LOS) with respect to the central office, as the relay node.

The configuring of the unit time frame includes configuring the unit time frame, such that the relay time slot and the shared time slot are included based on a predetermined ratio of a shared time to a relay time. The ratio of the shared time is predetermined based on an operating environment of the network.

The method further includes activating the shared time slot for relay transmission of the relay node if the final-stage node is not identified.

According to another aspect, there is provided a non-transitory computer-readable recording medium storing a program for executing a method for data communication based on time division multiple access (TDMA), performed by a central office of a network. The method includes identifying a plurality of nodes included in the network, configuring a unit time frame for data communication of the network, such that a plurality of dedicated time slots allocated for data transmission of each of the plurality of nodes and a shared time slot allocated and shared for data transmission of the plurality of nodes are included, identifying, among the plurality of nodes, a final-stage node predicted to enter a communication-disabled state within a predetermined time period based on status information of each node included in the plurality of nodes received from the dedicated time slot, and activating the shared time slot for the final-stage node.

According to still another aspect, there is also provided an electronic apparatus performing a method for data communication based on time division multiple access (TDMA), the electronic apparatus including a transceiver, a memory, and a processor. The processor controls at least one of the transceiver and the memory, and is configured to identify a plurality of nodes included in a network, configure a unit time frame for data communication of the network, such that a plurality of dedicated time slots allocated for data transmission of each of the plurality of nodes and a shared time slot allocated and shared for data transmission of the plurality of nodes are included, identify, among the plurality of nodes, a final-stage node predicted to enter a communication-disabled state within a predetermined time period based on status information of each node included in the plurality of nodes received from the dedicated time slot, and activate the shared time slot for the final-stage node.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

According to example embodiments, it is possible to efficiently utilize network resources in TDMA-based network data communication such that one or more nodes among nodes joined the network is enabled to transmit large volumes of data within a short period of time in a predetermined situation.

According to example embodiments, it is also possible to dynamically operate a network according to a data transmission requirement based on a status of a corresponding node, the status being determined based on status information of nodes joined the network.

According to example embodiments, it is still possible to efficiently operate a network, by adjusting an allocation ratio of a time slot based on network operating status.

Effects of the present disclosure are not limited to those described above, and other effects may be made apparent to those skilled in the art from the following description. It is to be understood that both the foregoing general description and the following detailed description are examples and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this specification, illustrate embodiments and together with the detailed description serve to explain the principles of the invention. In the drawings:

FIG. 1 is a conceptual diagram illustrating a configuration of a network communication system based on time division multiple access (TDMA), according to the present disclosure;

FIG. 2 is a flowchart illustrating a method for data communication based on TDMA according to an example embodiment of the present disclosure;

FIG. 3 is a flowchart illustrating a method of activating a time slot by identifying a new final-stage node according to an example embodiment of the present disclosure;

FIG. 4 is a flowchart illustrating a method for data communication based on TDMA according to an example embodiment of the present disclosure;

FIGS. 5A and 5B are example diagrams of a unit time frame for network communication based on TDMA according to an example embodiment of the present disclosure;

FIG. 6 is an example diagram of a user interface screen prompting whether to perform activation for a final-stage node according to an example embodiment of the present disclosure;

FIG. 7 is a block diagram illustrating a device corresponding to a central office and to a node communicating with the central office through a network according to an example embodiment of the present disclosure; and

FIG. 8 is an example diagram illustrating a configuration of an electronic apparatus performing a method for data communication according to an example embodiment of the present disclosure.

### DETAILED DESCRIPTION

Reference will now be made in detail to the example embodiments. Example embodiments relate to systems, devices, methods, and instructions for data communication based on time division multiple access (TDMA). More specifically, the present disclosure relates to data communication based on time division multiple access (TDMA) including, identifying a plurality of nodes included in the network, configuring a unit time frame for data communication of the network, such that a plurality of dedicated time slots allocated for data transmission of each of the plurality of nodes and a shared time slot shared and allocated for the data transmission of the plurality of nodes are included, identifying a final-stage node predicted to be in a communication-disabled state within a predetermined time period among the plurality of nodes based on status information of each node included the plurality of nodes received from the dedicated time slot, and activating the shared time slot for the final-stage node.

Terms used in the example embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. Accordingly, it should be noted that the terms used herein should be construed based on practical meanings thereof and the whole content of this specification, rather than being simply construed based on names of the terms.

In the entire specification, when an element is referred to as “comprising” or “including” another element, the element should not be understood as excluding other elements as long as there is no special conflicting description, and the element may include at least one other element. In addition, the terms "unit" and "module", for example, may refer to a component that exerts at least one function or operation, and may be realized in hardware or software, or may be realized by combination of hardware and software.

Throughout the specification, expression "at least one of a, b, and c" may include 'a only', 'b only', 'c only', 'a and b', 'a and c', 'b and c', or 'all of a, b, and c'.

The “terminal” referred hereinafter may be embodied as a computer of a portable device that can access a server or another terminal through a network. In the present disclosure, a computer may include, for example, a notebook computer, a desktop computer, and a laptop equipped with a web browser, and a portable device, for example, as a wireless communication device that guarantees portability and mobility, and may include all kinds of handheld wireless communication devices such as a communication-based terminal, a smartphone, and a tablet PC, supporting international mobile telecommunication (IMT), code division multiple access (CDMA), w-code division multiple access (W-CDMA), long-term evolution (LTE), and the like.

In the following description, example embodiments of the present disclosure will be described in detail with reference to accompanying drawings so that those skilled in the art can easily carry out the present disclosure. The present disclosure may be applied in many different forms and is not limited to the embodiments described herein.

Hereinafter, the example embodiments of the present disclosure will be described in detail with reference to accompanying drawings.

In describing the example embodiments, a description of contents well-known in the art to which the disclosure pertains and not directly relevant to the disclosure will be omitted. This is to make clearer description of the core aspects of the present disclosure by omitting unnecessary descriptions.

Similarly, one or more elements of accompanying drawings may be exaggeratively or schematically illustrated for the same reason. Additionally, the dimensions of each element are not necessarily drawn to scale. The same reference numeral has been assigned to elements that are identical or corresponding to one another in each drawing.

The benefits and characteristics of the present disclosure, as well as the method of achieving them will become clear by referencing the example embodiments described in detail below in accordance with the accompanying drawings. However, the present disclosure is not limited to the example embodiments described below but may be implemented in various forms, provided solely to complete the present disclosure and inform the scope of the present disclosure to those skilled in the art, and is only defined by the scope of the claims. Throughout the entire specification, the same reference numerals refer to the same element.

Here, it will be understood that each block diagram of the flowchart illustration and combinations of the blocks in the flowchart illustrations can be executed by computer program instructions. These computer program instructions may be mounted on the processor of a general-purpose computer, a special purpose computer, or other programmable data processing apparatus, so that the instructions executed by the processor of the computer or other programmable data processing apparatus create means for executing the functions specified in the flowchart block(s). These computer program instructions may also be stored in computer-usable or computer-readable memory that can direct a computer or other programmable data processing equipment to function in a particular manner, such that the instructions stored in the computer-usable or computer-readable memory produce an article of manufacture including instruction means that implement the function specified in the flowchart block(s). The computer program instructions may also be loaded into a computer or other programmable data processing apparatus to cause a series of operational steps to be performed on the computer or other programmable apparatus to produce a computer-executed process, so that the instructions performing the computer or other programmable apparatus provide steps for executing the functions described in the flowchart block(s).

Furthermore, each block of the flowchart illustrations may represent a portion of a module, a segment, or code, which includes one or more executable instructions for implementing a specified logical function(s). It should also be noted that in some alternative implementations, the functions noted in the blocks may occur out of order. For example, two blocks shown in succession may in fact be executed substantially concurrently, or the blocks may sometimes be executed in the reverse order, depending upon the functionality involved.

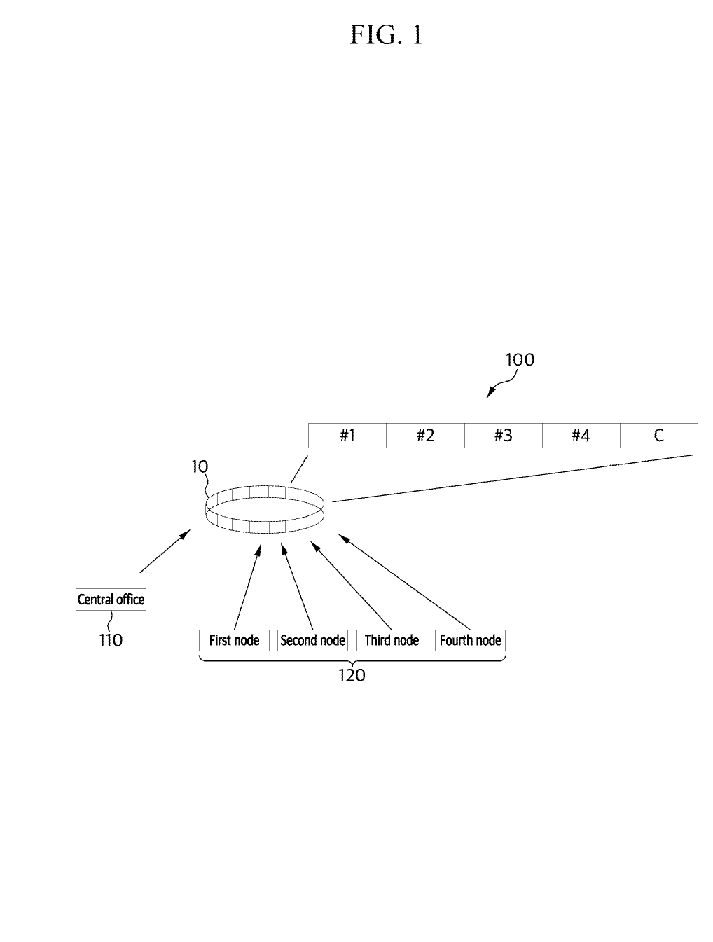

FIG. 1 is a conceptual diagram illustrating a configuration of a network 10 communication system based on time division multiple access (TDMA), according to the present disclosure. As shown in FIG. 1, a communication system of the network 10 based on TDMA may be configured to control data transmission and reception of a plurality of nodes 120 included in a central office (a central node) 110, and to manage communication through the network 10 by allocating time slots to each node, for example, by configuring and managing a unit time frame 100 for allocating time slots to each of a plurality of nodes 120.

According to the present disclosure, the network including the nodes 110 and 120 may be a Link-16 network, which is a tactical data link. A communication system of the Link-16 network manages data transmission of nodes joined the network by transmitting and receiving data based on TDMA, which involves dividing a 12-second-long unit time frame into 1536 time slots and allocating each time slot (7.8125ms) to each node that joined the network.

Referring to FIG. 1, the number of time slots available for each node within the unit time frame 100 utilized by the network 10 may be determined by the number of nodes included in the network 10. More specifically, the unit time frame 100 may include a time slot C allocated for data transmission of the central office and time slots #1 to #4 respectively allocated to a first node through a fourth node, the nodes communicating with the central office through the network 10.

Although the first node through the fourth nodes are illustrated as communicating with the central office in FIG. 1, this is only an example illustrating the communication system of the network 10 based on TDMA, and the number of nodes joining the network 10 in the communication system of the network 10 according to the present disclosure may not be limited to this, and any number of nodes may join the network 10 to communication with the central office 110.

In an example embodiment, the plurality of nodes 120 may correspond to a plurality of terminals that perform a predetermined task and communicate with the central office 110 in real time through the network 10. Here, the plurality of terminals corresponding to the plurality of nodes 120 may be physically damaged depending on the predetermined task and situation, which may result in one or more nodes of the plurality of nodes 120 being disabled for communication. For example, each of the plurality of nodes 120 may correspond to a communication module provided in a plurality of guided missile and communicating with the central office 110. Since the plurality of guided missiles are physically destroyed upon impact with a target during a predetermined task (e.g., a target interception), each guided missile may need to transmit large volumes of data to the central office 110 immediately preceding the impact.

In the present disclosure, a node that is predicted to enter a communication-disabled state within a predetermined time period in the network 10 during a predetermined task or the like may be referred to as a final-stage node. In an example embodiment, the final-stage node may be determined at the central office 110 based on status information of each node included in the plurality of nodes 120.

If a node becomes the final-stage node, the node may be required to transmit a large volume of data within a short period of time through the network 10, compared to standard daily data transmission. For example, when each of the plurality of nodes 120 correspond to a terminal installed in each of the plurality of guided missiles, the guided missile may include various sensors to detect or obtain target information, and may be configured to approach to the target to obtain information on location, dimension, form, and the like, of the target, and transmit the obtained information to the central office 110 in real time. Each guided missile may obtain a large volume of target information by approaching the target before being destroyed upon impact with the target, and may be required to transmit a large volume of data within a short period of time, compared to standard daily data transmission, as the obtained information needs to be transmitted to the central office 110 immediately prior to destruction (i.e., before becoming communication-disabled).

Meanwhile, the unit time frame 100 of FIG. 1 indicates a case in which time slots are allocated at a uniform ratio for data transmission of the central office 110 and each of the plurality of nodes 120 joined to the network 10. As shown in FIG. 1, when time slots within the unit time frame 100 are equally allocated between the central office 110 and the plurality of nodes 120 for data transmission, a final-stage node, which is required to transmit a large volume of data in a short period of time, compared to standard daily transmission, may enter a communication-disabled state and fail to transmit the data within its assigned time slot, potentially resulting in loss of valuable information. To address this, the present disclosure may provide a method for data transmission that enables dynamic management of time slots for the plurality of nodes 120 included in the network 10, based on the status of each node.

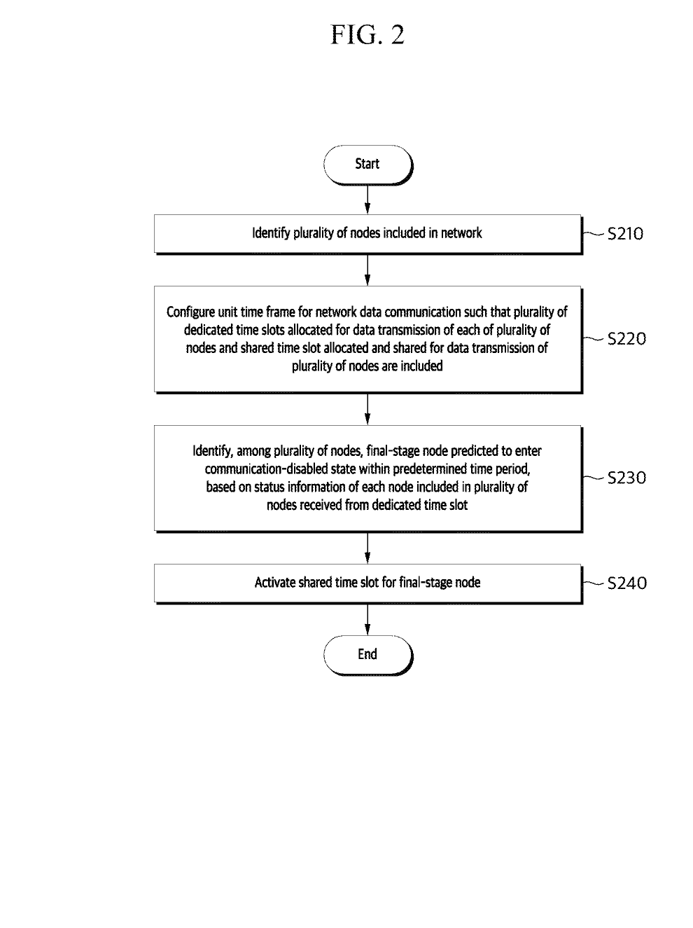

FIG. 2 is a flowchart illustrating a method for data communication based on TDMA according to an example embodiment of the present disclosure. While the data communication method shown in FIG. 2 is described as being performed by the central office 110 of FIG. 1 for illustrative purposes, the series of operations related to the data communication method, according to various example embodiments of the present disclosure, may be performed by a single physical device, or by a plurality of systematically coupled physical devices. For example, one or more operations required for the data communication method, according to the present disclosure, may be performed by one physical device and the remaining operations may be performed by another physical device. That is, for example, any one physical device may be implemented as a part of a device corresponding to the central office 110, while another physical device may be implemented as a part of an external device. In some cases, components that are separated and disposed on different physical devices may be systematically coupled to perform functions and operations of the central office that performs the data communication method. That is, for example, the central office of the present disclosure may include at least one sub-device, such that one or more operations described to be performed by the central office are performed by a first sub-device, and other operations are performed by a second sub-device.

According to an example embodiment of the present disclosure, as illustrated in FIG. 2, the method for data communication based on TDMA performed by a central office of a network may include identifying a plurality of nodes includes in the network (S210), configuring a unit time frame for data communication of the network, such that a plurality of dedicated time slots allocated for data transmission of each of the plurality of nodes and a shared time slot shared and allocated for data transmission of the plurality of nodes are included (S220), identifying, among the plurality of nodes, a final-stage node predicted to enter a communication-disabled state within a predetermined time period (S230), and activating the shared time slot for the final-stage node (S240).

In operation S210, the central office 110 may identify the plurality of nodes 120 included in a network. The network may correspond to the network 10 of FIG. 1, and may be a data communication network based on TDMA. According to various example embodiments of the present disclosure, the network may include a Link-16 tactical data link network, for example. The network may correspond to a communication network for transmitting and receiving real-time data to and from aircraft, battleships, ground forces, and the like, and for transmitting and receiving data related to task commands.

In an example embodiment, the central office 110 may serve as a central node in the network, and the plurality of nodes 120 identified by the central office 110 may include communication terminals placed on devices, such as guided missiles and survey drones, that are launched and controlled from aircraft, battleships, and combat vehicles for predetermined tasks. Accordingly, the plurality of nodes 120 may be configured to transmit data obtained or generated while performing the predetermined tasks to the central office through the network. In an example embodiment, the plurality of nodes 120 may be predicted to sequentially enter a communication-disabled state depending on a predetermined task. For example, the plurality of nodes may correspond to nodes including communication terminals provided on each of guided missiles that are sequentially launched from a battleship, for example, to approach its target.

In operation S220, the central office 110 may configure a unit time frame, such that a plurality of dedicated time slots allocated for data transmission of each of the plurality node 120 and a shared time slot allocated and shared for data transmission of the plurality of nodes 120 are included. In the present disclosure, the unit time frame may correspond to the unit time frame 100 of FIG. 1, and may also correspond to a time cycle configured to manage data communication in a TDMA-based network.

Additionally, in the present disclosure, the term “dedicated time slot” may refer to a time slot allocated to enable a predetermined node among the plurality of nodes 120 or the central office 110 to transmit data exclusively, and the term “shared time slot” may refer to a time slot that is not fixedly allocated to any single node, but is instead allocated and shared among plurality of nodes 120 in an inactivated state, which may be dynamically activated for a predetermined node under the control of the central office 110 based on an operating status of the network.

In the present disclosure, the central office 110 may configure a ratio of the shared time slot to the unit time frame differently, based on the operating status of the network. In an example embodiment, the central office 110 may configure the unit time frame, such that the shared time slot includes more time slots than the plurality of dedicated time slots. In the case where the shared time slot includes more time slots than the dedicated time slot, activation of the shared time slot for a predetermined node enables the node to transmit a large volume of data within a short period of time.

In an example embodiment, the network may include a relay node that, according to an instruction from the central office 110, transmits data transmitted from another node of the plurality of nodes to the central office 110, to extend data transmission and reception range. The relay node may be determined, among the plurality of nodes, based on a location, signal strength, and distance from the central office 110 of each node.

In an example embodiment, the central office 110, in configuring the unit time frame, may identify a relay node, among the plurality of nodes, to perform relay transmission, and configure the unit time frame to include more relay time slots allocated for relay transmission. In an example embodiment, the central office 110 may dynamically identify a relay node from the plurality of nodes based on the status of the network and the plurality of nodes. For example, the central office 110 may identify, from the plurality of nodes, a node closest to the central office 110 among nodes determined to be in line-of-sight (LOS) with respect to the central office 110. Accordingly, the central office 110 may transmit or receive data to and from a node that is outside communication range or that does not maintain LOS, via the relay node.

In an example embodiment, the central office 110 may configure the unit time frame, such that a relay time slot and the shared time slot is included, based on a predetermined ratio of a shared time to a relay time. The ratio of the shared time may be configured based on the network operating environment. More specifically, the ratio of shared time to relay time may be determined by the status of a node within the network, required amount of data transmission, and the type of task. For example, when transmission of a large volume of data needs to be prioritized in a predetermined network environment, the ratio of the shared time may be configured to be high, such that more shared time slots are included in the unit time frame. Alternatively, when the plurality of nodes within the network require continuous communication with the central office 110, the ratio of the shared time may be configured to be low and the unit time frame may be configured to include more realty time slots. According to various example embodiments of the present disclosure, the unit time frame, including the relay time slot and the shared time slot, may be adaptively configured based on real-time network status information collected from the central office 110 and user input.

In operation S230, the central office 110 may identify, from the plurality of nodes 120, a final-stage node predicted to enter a communication-disabled state within a predetermined time period based on status information of each node of the plurality of nodes 120. In an example embodiment, the status information used by the central office 110 to identify the final-stage node may be data related to communication status of each node or status of a predetermined task. More specifically, the status information may include at least one of location information, speed information, target detection information, energy information, and communication status information of each node. In an example embodiment, the central office 110 may confirm whether each node is predicted to enter a communication-disabled state within a predetermined time period based on the status information of each node, and identify the final-stage node based on this information. In the present disclosure, the final-stage node may refer to a node predicted to enter a communication-disabled state within a predetermined time period in a network, depending on a predetermined task or the like. The central office 110 may identify whether each of the plurality of nodes is the final-stage node based on the status information of each node. For example, the central office 110 may identify whether a node, among the plurality of nodes 120, is approaching its target based on location information received from the node, determine whether the node is predicted to be destroyed and enter a communication-disabled state within a predetermined time period, and confirm the node as the final-stage node.

In operation S240, the central office 110 may activate the shared time slot for the final-stage node. When the central office 110 activates the shared time slot for the final-stage node, the final-stage node may be enabled to transmit data using the shared time slot in addition to its predetermined dedicated time slot, thereby enabling transmission of large volumes of data within a short period of time through the network.

In an example embodiment, the central office 110, in activating the shared time slot for the final-stage node, may include obtaining user input confirming activation of the shared time slot, and activating the shared time slot for the final-stage node in response to the user input. In this regard, the central office 110 may include a user interface (UI) for operating and managing the network and the plurality of nodes.

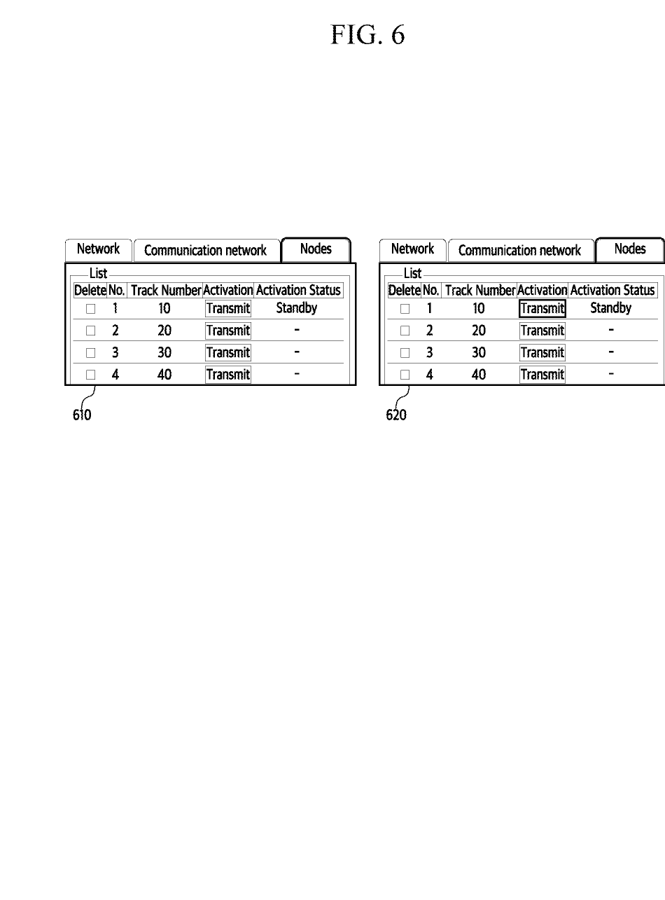

When a node, among the plurality of nodes, is confirmed as the final-stage node, the central office 110 may prompt a decision on whether to activate the shared time slot for the node, or provide related information, through the user interface. For example, the central office 110 may display the status information (such as location, speed, and energy status) of the final-stage node and prompt a user to choose whether to activate the shared time slot. Detailed description of the user interface prompting a decision on whether to activate the final-stage node through the user interface is shown in FIG. 6.

In an example embodiment, in a case where a final-stage node is not identified, the central office 110 may activate the shared time slot for relay transmission of the relay node. Through this, the availability of the shared time slot may be enhanced even in the absence of a final-stage node, as well as the efficiency of relay transmission in the network, thereby enabling the central office 110 to perform continuous data communication with the plurality of nodes 120 over a wider communication range.

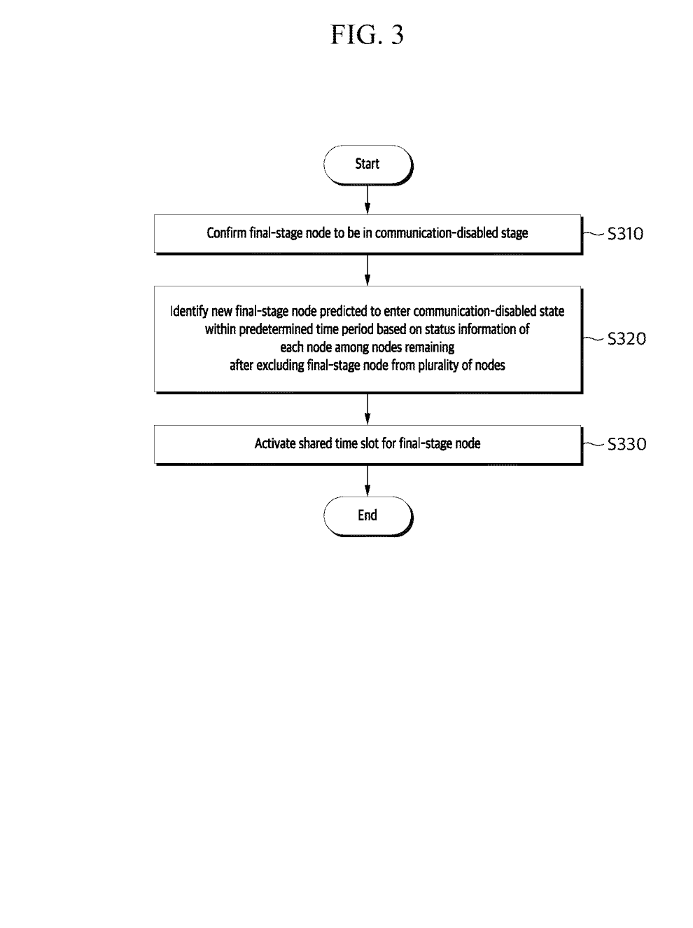

FIG. 3 is a flowchart illustrating a method of activating a time slot by identifying a new final-stage node according to an example embodiment of the present disclosure. The method illustrated in FIG. 3 may be performed by the central office 110 after activating the shared node for the final-stage node, when the final-stage node that transmits the data within the shared node is confirmed to be disabled for communication.

Referring to FIG. 3, when the final-stage node is confirmed to be in a communication-disabled state (S310), the central office 110 may identify a new final-stage node, predicted to enter a communication-disabled state within a predetermined time period, based on the status information of each node of the remaining nodes after excluding the final-stage node from the plurality of nodes (S320), and activate the shared time slot for the new final-stage node (S330).

The identification of the new final-stage node that is predicted to enter a communication-disabled state within a predetermined time period based on status information of each node of the remaining nodes after excluding the final-stage node from the plurality of nodes, performed by the central office 110 in operation S320, may correspond to operation S230 of FIG. 2. In operation S320, the central office 110 may identify a new final-stage node based on at least one of location information, speed information, target detection information, energy information, and communication status information of each of the remaining nodes excluding the final-stage node that was confirmed as disabled for communication.

The central office 110 may identify a final-stage node predicted to enter a communication-disabled state in a predetermined time period among the plurality of nodes, and whenever the final-stage node is confirmed to have entered the communication-disabled state, the central office 110 may identify a new final-stage node from the remaining nodes and activate the shared time slot for the new final-stage node to enable the transmission of a large volume of data from the node.

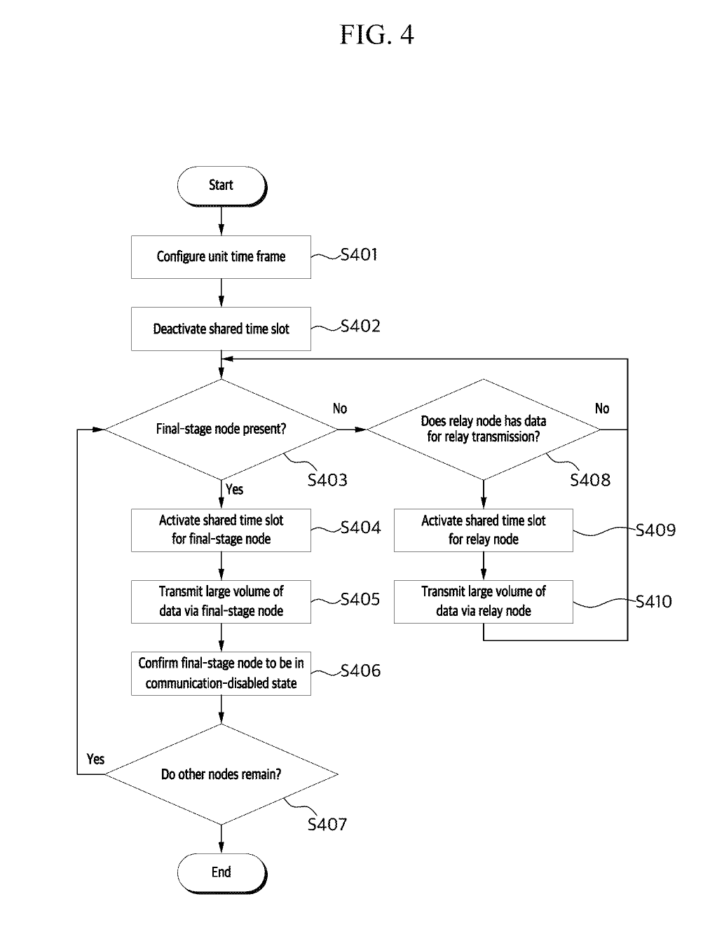

FIG. 4 is a flowchart illustrating a method for data communication based on TDMA of a plurality of nodes, performed by the central office 110 according to an example embodiment of the present disclosure. The data communication method illustrated in FIG. 4 includes a data communication method performed by the central office 110 in a network including the central office 110 and the plurality of nodes 120. FIG. 4 illustrates a series of operations, beginning with the initial configuration of the shared time slot (S401). The operations include activation of a time slot for the final-stage node and relay node (S404, S409), data transmission (S405, S410), and confirmation of communication-disabled state and a follow-up operation (S406, S407). A redundant description of the details provided with reference to FIGS. 2 and 3 above will be omitted.

The central office 110 may configure the unit time frame, such that the shared time slot, relay time slot, and/or dedicated time slot are included, in operation S401 and may deactivate the shared time slot included in the unit time frame in operation S402. The shared time slot may be included in the unit time frame in a deactivated state for all nodes, and the central office 110 may allocate time resources more adaptively and efficiently for the network operating environment by dynamically activating the shared slot for one or more of the plurality of nodes.

In operation S403, the central office 110 may identify whether a final-stage node is present in the plurality of nodes included in the network, and may activate the shared time slot for the final-stage node to enable transmission of a large volume of data, in operations S404 and S405 if the final-stage node is present. If the final-stage node is confirmed to be in a communication-disabled state in operation S406, the central office 110 may identify in operation S407 whether another node remains in the network and subsequently return to operation S403 to check for a new final-stage node.

If no final-stage node is identified in operation S403, the central office 110 may check in operation S408 for data to be relay-transmitted from the relay node. If data requiring relay transmission from the relay node, the central office 110 may utilize the relay time slot, or activate the shared time slot for the relay node in operation S409, to enable the relay node to transmit large volumes of data in operation S410.

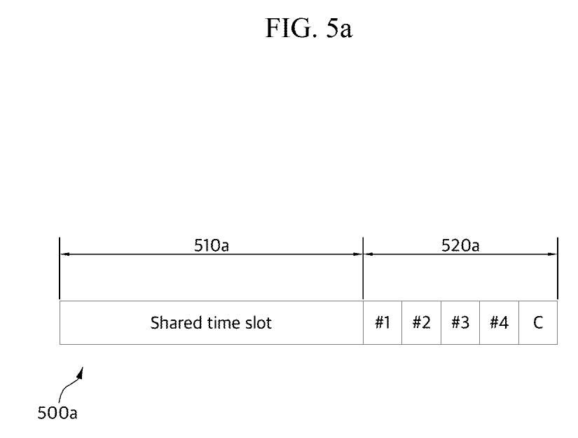

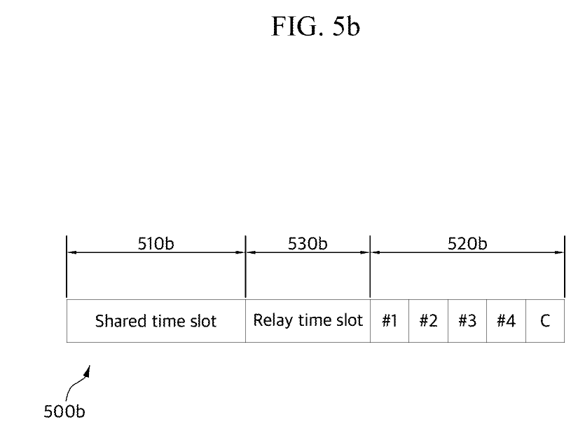

FIGS. 5A and 5B are diagrams illustrating a unit time frame for network communication based on TDMA, configured by the central office 110 according to an example embodiment of the present disclosure. FIGS. 5A and 5B respectively represents a unit time frame 500a and a unit time frame 500b. The unit time frame 500a is configured when there is no relay node present, while the unit time frame 500b is configured when where is a relay node present. The unit time frames 500a and 500b of FIGS. 5A and 5B illustrate a ratio of allocated time slots, however a disposition order of the time slots does not correspond to an actual allocation order of the time slots.

Referring to FIG. 5A, the unit time frame 500a may be configured to include a shared time slot 510a and a dedicated time slot 520a. The shared time slot 510a is not fixedly allocated to a predetermined node, among the plurality of nodes included in the network, but is instead allocated and shared among the plurality of nodes in an inactive state during initial configuration. The dedicated time slot 520a is allocated to each node included in the network for exclusive data transmission. The dedicated time slot 520a, for example, may include dedicated time slots #1, #2, #3, and #4, respectively allocated to a first node through a fourth node, and a dedicated time slot C allocated for data transmission of the central office. The type of a dedicated time slot allocated to each node included in the dedicated time slot 520a is not limited thereto, but may include types of dedicated time slots allocated respectively according to the number of the plurality of nodes 120 included in the network. Furthermore, a ratio of the dedicated time slot allocated to each node may be determined based on the number of the plurality of nodes 120 included in the network. The shared time slot 510a may be configured to be dynamically activated for a predetermined node under the control of the central office 110 based on network operating status. The central office 110 may identify a final-stage node based on the status information of each node and may activate the shared time slot 510a for the final-stage node to enable transmission of a large volume of data.

Referring to FIG. 5B, the unit time frame 500b may be configured to further include a relay time slot 530b, which is allocated for relay transmission of the relay node for network relay transmission, in addition to the shared time slot 510a and the dedicated time slot 520b. In an example embodiment, the central office 110 may activate the shared time slot 510b for the final-stage node to enable transmission of large volumes of data. Alternatively, if a final-stage node is not identified among the plurality of nodes 120 included in the network, the central office 110 may activate the shared time slot 510b together with the relay time slot 530b for the relay node to enable relay transmission.

FIG. 6 is an example diagram of a user interface screen prompting whether to perform activation for a final-stage node according to an example embodiment of the present disclosure. When a node among the plurality of nodes is confirmed as the final-stage node, the central office 110 may prompt a user to decide on whether to activate the shared time slot through the user interface. Here, as illustrated in FIG. 6, the central office 110 may output a screen 610 displaying list of nodes included in the network and activation status of the shared time slots, through the user interface. If the first node is confirmed as the final-stage node based on the status information of each node received via the network, the central office 110 may activate an input interface that allows the activation of the shared time slot for the first node, and output a screen 620 that shows the shared time slot’s activation status for that node as “Standby”.

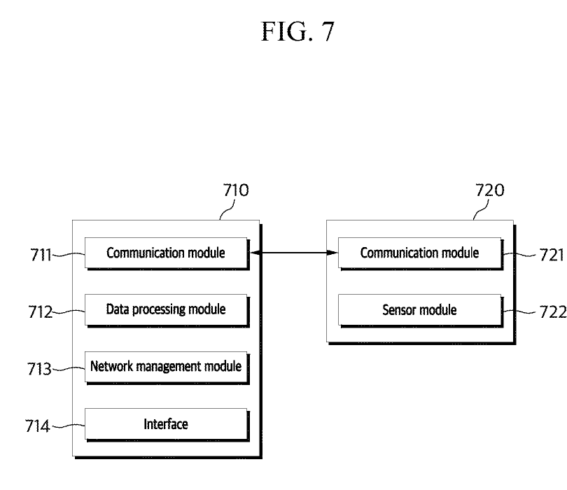

FIG. 7 is a block diagram illustrating a device corresponding to the central office 110 and to the node 120 communicating with the central office 110 through a network according to an example embodiment of the present disclosure. Apparatus 710 and 720 of FIG. 7 are examples illustrating configurations of a device corresponding to the central office 110 and of a device corresponding to the node 120, according to the present disclosure. The central office 110 and the node 120 according to the present disclosure may include configurations other than those illustrated in FIG. 7, and may include devices implemented to perform data communication over a network according to various example embodiments of the present disclosure.

The apparatus 710 may perform functions of the central office 110 of FIG. 1. The apparatus 710 may include a communication module 711, a data processing module 712, a network management module 713, and an interface 714. The communication module 711 may include hardware such as a transceiver, according to the network status, and may transmit and receive data utilizing time slots in a TDMA-based network. The data processing module 712 may perform data processing, such as identifying a final-stage node or a relay node through analysis of status information of the collected plurality of nodes 120. The network management module 713 may manage overall structure of the network to facilitate communication between the central office 110 and the plurality of nodes 120. For example, the network management module 713 may control configurations of time slots within a unit time frame and manage the unit time frame of the network by identifying a relay node present in the plurality of nodes included in the network, identifying a final-stage node, and responding to a communication-disabled state. The interface 714 may receive a user input to operate and manage the network and the plurality of nodes, and may output information related to the network. The interface 714 may be implemented as various devices, such as an input device (e.g., a touchscreen display, a keypad, a mouse, or a software-based input interface), and an output device (e.g., a monitor or a display). Without being limited to these examples, the interface 714 may also be implemented as a device that receives a user input and outputs status information of a network or status information of a plurality of nodes included in the network. When a node among the plurality of nodes is confirmed as the final-stage node, the apparatus 710 may prompt a user via the interface 714 to decide on whether to activate the shared time slot for the node, or provide related information.

An apparatus 720 may correspond to the plurality of nodes 120, and may include a communication module 721 and a sensor module 722. For example, the apparatus 720 may be a device, such as a guided missile and a survey drone, that performs a predetermined task. The apparatus 720 may obtain information related to a task or status information of the apparatus 720 via the sensor module 722, and may transmit the information related to the task and the status information of the apparatus 720 or receive an instruction, via the communication module 721.

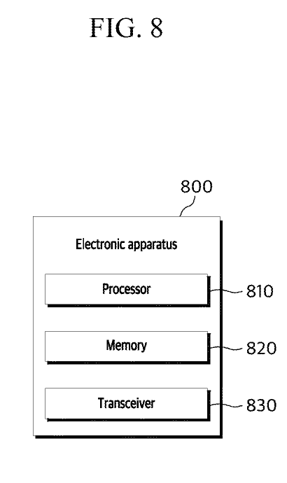

FIG. 8 is an example diagram illustrating a configuration of an electronic apparatus performing a method for data communication according to an example embodiment of the present disclosure. An electronic apparatus 800 may correspond to the apparatus 710 of FIG. 7 and the central office 110 of FIG. 1. Referring to FIG. 8, the electronic apparatus 800 may include a memory 820 and a transceiver 830. The electronic apparatus 800 may be coupled to and exchange data with a user external device via the transceiver 830.

The processor 810 may include at least one of the devices described above with reference to FIGS. 1, 2, 3, 4, 5A, 5B, 6, and FIG. 7, or perform at least one method described above with reference to FIGS. 1, 2, 3, 4, 5A, 5B, 6, and FIG. 7. The memory 820 may store information for performing at least one method described above with reference to FIGS. 1, 2, 3, 4, 5A, 5B, 6, and FIG. 7. The memory 820 may be a volatile memory or a non-volatile memory.

The processor 810 may execute a program and control the electronic apparatus 800 that processes information. Code of a program executed by the processor 810 may be stored in the memory 820.

Additionally, the electronic apparatus 800 of the example embodiment may further include an interface for providing information to a user or a manager.

However, although example embodiments of the present disclosure are set forth in the present specification and drawings and specific terms are used herein, they are merely provided in a general sense to easily explain the technical idea of the present disclosure and help understanding of the present disclosure and are not intended to limit the scope of the present disclosure. It will be apparent to those skilled in the art that various modifications and variations can be made in the systems, devices, methods and instructions for data communication based on time division multiple access (TDMA) of the present disclosure without departing from the spirit or scope of the invention. Thus, it is intended that the present disclosure covers the modifications and variations of this invention provided they come within the scope of the appended claims and their equivalents.

The terminal according to the above-described example embodiments may include a processor, a memory for storing and executing program data, a permanent storage such as a disk drive, a communications port for communicating with external devices, a user interface device such as a touch panel, a key and a button, and the like. Methods realized by software modules or algorithms may be stored in a computer-readable recording medium as computer-readable code or program commands which may be executed by the processor. Here, the computer-readable recording medium may be a magnetic storage (such as a read-only memory (ROM), a random-access memory (RAM), a floppy disk, and a hard disk), an optical storage (such as a CD-ROM, and a digital versatile disc (DVD)), and the like. The computer-readable recording medium may be dispersed to computer systems connected by a network so that the computer-readable code may be stored and executed in a dispersion manner. The medium may be read by a computer, may be stored in a memory, and may be executed by the processor.

The example embodiments may be represented by functional blocks and various processing steps. These functional blocks may be implemented by various numbers of hardware and/or software configured to execute specific functions. For example, the example embodiments may adopt integrated circuit configurations such as a memory, a processor, a logic circuit, and a look-up table that may execute various functions by controlling one or more microprocessors or other control devices. Similar to the elements being implemented by software programming or software elements, the example embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the example embodiments may adopt the related art for electronic environment setting, signal processing, and/or data processing, for example. The terms "mechanism", "element", "means", and "configuration" may be widely used and are not limited to mechanical and physical components. These terms may include meaning of a series of software routines in association with a processor, for example.

The example embodiments described above are merely examples and other embodiments may be implemented within the scope of the following claims.

What is claimed is:

1. A method for data communication based on time division multiple access (TDMA), performed by a central office of a network, the method comprising:
identifying a plurality of nodes included in the network;
configuring a unit time frame for data communication of the network, such that a plurality of dedicated time slots allocated for data transmission of each of the plurality of nodes and a shared time slot allocated and shared for the data transmission of the plurality of nodes are included;
identifying, among the plurality of nodes, a final-stage node predicted to enter a communication-disabled state within a predetermined time period based on status information of each node included the plurality of nodes received from the dedicated time slot; and
activating the shared time slot for the final-stage node.

2. The method of claim 1, wherein the plurality of nodes are predicted to sequentially enter the communication-disabled state according to a predetermined task.

3. The method of claim 1, wherein the configuring of the unit time frame comprises configuring the unit time frame, such that the shared time slot includes more time slots than the plurality of dedicated time slots.

4. The method of claim 1, wherein the identifying of the final-stage node comprises:
identifying whether each node is predicted to enter the communication-disabled state within the predetermined time period based on at least one of location information, target detection information, and speed information, of each node, included in the status information of each node; and
identifying the final-stage node based on whether each node is predicted to enter the communication-disabled state within the predetermined time period.

5. The method of claim 1, wherein the activating of the shared time slot for the final-stage node comprises:
obtaining a user input confirming whether to activate the shared time slot for the final-stage node; and
activating the shared time slot for the final-stage node in response to the input.

6. The method of claim 1, further comprising:
identifying, when the final-stage node is confirmed to be in the communication-disabled state, a new final-stage node predicted to enter the communication-disabled state within the predetermined time period based on the status information of each node of nodes remaining after excluding the final-stage node from the plurality of nodes; and
activating the shared time slot for the new final-stage node.

7. The method of claim 1, wherein the configuring of the unit time frame comprises:
identifying, among the plurality of nodes, a relay node to perform relay transmission of the plurality of nodes; and
configuring the unit time frame to further include a relay time slot allocated for the relay transmission.

8. The method of claim 7, wherein the identifying of the relay node comprises identifying, among the plurality of nodes, a node nearest to the central office among nodes determined to be in a line of sight (LOS) with respect to the central office, as the relay node.

9. The method of claim 7, wherein the configuring of the unit time frame comprises configuring the unit time frame, such that the relay time slot and the shared time slot are included based on a predetermined ratio of a shared time to a relay time, and
wherein the ratio of the shared time is predetermined based on an operating environment of the network.

10. The method of claim 7, further comprising activating the shared time slot for relay transmission of the relay node if the final-stage node is not identified.

11. A non-transitory computer-readable recording medium storing a program for executing a method for data communication based on time division multiple access (TDMA), performed by a central office of a network, wherein the method comprises:
identifying a plurality of nodes included in the network;
configuring a unit time frame for data communication of the network, such that a plurality of dedicated time slots allocated for data transmission of each of the plurality of nodes and a shared time slot allocated and shared for data transmission of the plurality of nodes are included;
identifying, among the plurality of nodes, a final-stage node predicted to enter a communication-disabled state within a predetermined time period based on status information of each node included in the plurality of nodes received from the dedicated time slot; and
activating the shared time slot for the final-stage node.

12. An electronic apparatus performing a method for data communication based on time division multiple access (TDMA), the electronic apparatus comprising:
a transceiver;
a memory; and
a processor,
wherein the processor controls at least one of the transceiver and the memory, and is configured to:
identify a plurality of nodes included in a network;
configure a unit time frame for data communication of the network, such that a plurality of dedicated time slots allocated for data transmission of each of the plurality of nodes and a shared time slot allocated and shared for data transmission of the plurality of nodes are included;
identify, among the plurality of nodes, a final-stage node predicted to enter a communication-disabled state within a predetermined time period based on status information of each node included in the plurality of nodes received from the dedicated time slot; and
activate the shared time slot for the final-stage node.
